(19) United States
(12) Patent Application Publication
(10) Pub. No.: US 2016/0194417 A1
(43) Pub. Date: Jul. 7, 2016

(54) DEGRADABLE POLYMER RESINS AND METHODS FOR THEIR PREPARATION

(71) Applicant: EMPIRE TECHNOLOGY DEVELOPMENT LLC, Wilmington, DE (US)

(72) Inventors: William Brenden CARLSON, Seattle, WA (US); Vincenzo CASASANTA, III, Woodinville, WA (US); Gregory D. PHELAN, Cortland, NY (US)

(73) Assignee: EMPIRE TECHNOLOGY DEVELOPMENT LLC, Wilmington, DE (US)

(21) Appl. No.: 14/910,874

(22) PCT Filed: Aug. 7, 2013
(86) PCT No.: PCT/US2013/053988

§ 371 Date: Feb. 8, 2016

(51) Int. Cl. C08F 120/14; C08G 65/26; B01J 19/12; C08L 25/06; C08G 18/38; C08G 63/685; C08F 216/18

(52) U.S. Cl. CPC C08F 120/14; C08G 63/6858; C08G 65/2609; C08F 216/18; C08L 25/06; C08G 18/3838; B01J 19/121

(57) ABSTRACT

Disclosed are polymers having one or more two-photon absorbing chromophores in a backbone of the polymers. The polymers degrade upon two-photon excitation, which allows for easy decomposition of polymeric products made therefrom. The decomposition can occur when the polymer is exposed to light of intensities sufficient to induce the two-photon excitation, which in turn cleaves the polymer at one or more sites where the chromophores are attached.

### BACKGROUND

Food packaging is a major contributor to environmental pollution. Vast amounts of garbage are increasingly making an appearance in the middle of the ocean, and the garbage is largely made up of food packaging materials. Marine life can become entangled in the garbage or ingest the garbage, which can lead to death of an individual species or even extinction of an entire species. Disposed food packaging materials can be equally destructive on land. Many animals feed on food wastes at waste disposal sites. Entire ecosystems can be formed around these sites. The food wastes can be harmful to the animals when ingested. Like marine life, land animals can also consume the plastics used in food packaging materials. The consumed plastics can leach harmful materials into the animal or disrupt their digestive tract causing harm. Disposed food packaging materials are therefore rapidly exhausting landfills and harming wildlife.

Billions of pounds of various products are used to manufacture food packaging materials. Can coatings is a market worth in excess of three billion dollars. The US food packaging demand is projected to reach $25 billion in 2013. Despite the large market and constant technological progress, most new materials used in food packaging have not been fully evaluated in terms of either food safety or their environmental impact. The most widely used packaging materials, such as plastics, are manufactured from fossil fuels and other non-renewable sources, and are therefore not fully recyclable or biodegradable. Disposal of those packaging materials into landfills can contaminate soil and waterways, eventually causing harm to ecosystems and wildlife; all of which add to the economic and social impact of the use of such materials. The food packaging industry is working towards environmental sustainability, progress of which will include the development of new and environmentally-friendly packaging materials.

### SUMMARY

In an embodiment, a polymer resin having a polymeric backbone, includes a first repeating unit and a second repeating unit, wherein the first repeating unit has a two-photon absorbing chromophore in the polymeric backbone. The two-photon absorbing chromophore may be any two-photon absorbing chromophore known in the art.

In an embodiment, a recyclable material includes a polymer resin having a polymeric backbone, the polymer resin including a first repeating unit and a second repeating unit, wherein the first repeating unit has a two-photon absorbing chromophore in the polymeric backbone. The two-photon absorbing chromophore may be any two-photon absorbing chromophore known in the art.

In an embodiment, a method of preparing a polymer resin includes polymerizing a first monomer and a second monomer, wherein the first monomer has a two-photon absorbing chromophore, and wherein the two-photon absorbing chromophore is incorporated into a backbone of the polymer resin. The two-photon absorbing chromophore may be any two-photon absorbing chromophore known in the art.

In an embodiment, a method of degrading a polymer includes exposing the polymer to light, the polymer including a first repeating unit and a second repeating unit, wherein the first repeating unit has a two-photon absorbing chromophore in a polymeric backbone of the polymer. The two-photon absorbing chromophore may be any two-photon absorbing chromophore known in the art.

### DESCRIPTION OF DRAWINGS

For a fuller understanding of the nature and advantages of the disclosed embodiments, reference can be made to the following detailed description in connection with the accompanying figures.

FIG. 1 depicts a Jablonski diagram comparing simple absorption (A) and two-photon absorption (B) processes.

FIG. 2 depicts several exemplary step growth polymers in accordance with some embodiments.

FIG. 3 depicts several exemplary step growth polymers in accordance with some embodiments.

FIG. 4 depicts exemplary functional two-photon absorbing chromophore in chain growth systems in accordance with some embodiments.

FIG. 5 depicts an exemplary reaction to form a two-photon absorbing chromophore containing polyethylene terephthalate (PET) polymer.

FIG. 6 depicts a section of plastic material with the two-photon absorbing chromophore incorporated into a polymeric backbone in accordance with some embodiments.

### DETAILED DESCRIPTION

Before the present compositions and methods are described, it is to be understood that they are not limited to the particular compositions, methodologies or protocols described, as these may vary. It is also to be understood that the terminology used in the description is for the purpose of describing the particular versions or embodiments only, and is not intended to limit their scope.

“Alkenylene” refers to a divalent alkenyl moiety, meaning the alkenyl moiety is attached to the rest of the molecule at two positions. Alkenylene groups may be substituted or unsubstituted.

“Alkenyl” means a straight or branched alkyl group having one or more double carbon-carbon bonds and 2-20 carbon atoms, including, but not limited to, ethenyl, 1-propenyl, 2-propenyl, 2-methyl-1-propenyl, 1-butenyl, 2-butenyl, and the like. In some embodiments, the alkenyl chain is from 2 to 10 carbon atoms in length, from 2 to 8 carbon atoms in length, from 2 to 6 carbon atoms in length, or from 2 to 4 carbon atoms in length.

“Arylene” means a bivalent aryl group that links one group to another group in a molecule. Arylene groups may be substituted or unsubstituted.

“Aryl” means a monocyclic, bicyclic, or polycyclic (e.g., having 2, 3 or 4 fused rings) aromatic hydrocarbons. In some embodiments, aryl groups have from 6 to 20 carbon atoms or from 6 to 10 carbon atoms. Examples of aryl groups include, but are not limited to, phenyl, biphenyl, benzyl, naphthyl, anthracenyl, phenanthrenyl, indanyl, indenyl, tetrahydronaphthyl, and the like.

“Heteroaryl” means an aromatic heterocycle having up to 20 ring-forming atoms (e.g., C) and having at least one heteroatom ring member (ring-forming atom) such as sulfur, oxygen, or nitrogen. In some embodiments, the heteroaryl group has at least one or more heteroatom ring-forming atoms, each of which are, independently, sulfur, oxygen, or nitrogen. In some embodiments, the heteroaryl group has from 3 to 20 ring-forming atoms, from 3 to 10 ring-forming atoms, from 3 to 6 ring-forming atoms, or from 3 to 5 ring-forming atoms. In some embodiments, the heteroaryl group contains 2 to 14 carbon atoms, from 2 to 7 carbon atoms, or 5 or 6 carbon atoms.

“Substituted aryl” refers to aryl as just described in which one or more hydrogen atoms attached to any carbon atoms is replaced by one or more functional groups such as alkyl, substituted alkyl, cycloalkyl, substituted cycloalkyl, heterocycloalkyl, substituted heterocycloalkyl, halogen, halogenated alkyl (e.g., CF 3), hydroxy, amino, phosphino, alkoxy, amino, thio and both saturated and unsaturated cyclic hydrocarbons which are fused to the aromatic ring(s), linked covalently or linked to a common group such as a methylene or ethylene moiety.

“Cycloalkyl” means non-aromatic cyclic hydrocarbons including cyclized alkyl, alkenyl, and alkynyl groups that contain up to 20 ring-forming carbon atoms. Cycloalkyl groups can include mono- or polycyclic ring systems such as fused ring systems, bridged ring systems, and spiro ring systems. In some embodiments, polycyclic ring systems include 2, 3, or 4 fused rings. A cycloalkyl group can contain 3 to 15, 3 to 10, 3 to 8, 3 to 6, 4 to 6, 3 to 5, or 5 or 6 ring-forming carbon atoms. Ring-forming carbon atoms of a cycloalkyl group can be optionally substituted by oxo or sulfido. Examples of cycloalkyl groups include, but are not limited to, cyclopropyl, cyclobutyl, cyclopentyl, cyclohexyl, cycloheptyl, cyclooctyl, cyclononyl, cyclopentenyl, cyclohexenyl, cyclohexadienyl, cycloheptatrienyl, norbornyl, norpinyl, norcarnyl, adamantyl, and the like. Also included in the definition of cycloalkyl are moieties that have one or more aromatic rings fused (having a bond in common with) to the cycloalkyl ring, for example, benzo or thienyl derivatives of pentane, pentene, hexane, and the like (e.g., 2,3-dihydro-1H-indene-1-yl, or 1H-inden-2(3H)-one-1-yl).

“Heterocycloalkyl” means non-aromatic heterocycles having up to 20 ring-forming atoms including cyclized alkyl, alkenyl, and alkynyl groups, where one or more of the ring-forming carbon atoms is replaced by a heteroatom such as an O, N, or S atom. Hetercycloalkyl groups can be mono or polycyclic (e.g., fused, bridged, or spiro systems).

Disclosed are monomers and polymers which allow for easy decomposition of polymeric products made therefrom. The decomposed products can be used to create other high value materials and products. Environmental damage and volume of waste created from packaging materials can thus be greatly reduced. The monomers and polymers can be used in conjunction with one or more resin systems. Use of monomers having a two-photon absorbing chromophore can incorporate the chromophore into the backbone of the resin system. The two-photon absorbing chromophore is capable of absorbing two photons of high intensity light simultaneously resulting in the decomposition. The decomposition can be selective, as simultaneous absorption of two-photons of high intensity light does not occur from exposure to ambient light, whether natural or synthetic. The result of the decomposition is a fragmenting of the polymer into fragments of reduced molecular weights, which allows for the fragments to be easily processed and/or recycled.

Methods for forming such decomposable monomers and polymers are disclosed. The polymers that include the two-photon absorbing chromophore contain specific linker moieties in the polymer backbone that can be cleaved under certain conditions not encountered in ambient conditions, and are therefore stable and durable. The conditions to cleave the polymer backbone include exposure to high intensity light sources that have a photon flux sufficient to provide two photons to be absorbed simultaneously by the chromophore. The two-photon absorbing chromophore may be used in a variety of materials that use a wide variety of polymeric resins. For example, polymers such as polyethylene terephthalate (PET), polycarbonate, epoxies, polyurethane, polyurea, melamine-formaldehyde polymers, polyesters, polyethers, novolac, bakelite, nylon, polyamides, acrylics, styrenics, polyimide, polyamide-imide, condensation polymers, chain growth polymers may be modified to include the two-photon absorbing chromophore rendering component parts thereof easily reclaimable and reusable so that they do not add to landfills. In some embodiments, the modified polymeric resin, containing the two-photon absorbing chromophore maintains substantially the same or similar properties as the unmodified resin. For example, a modified PET will have substantially the same or similar properties as an unmodified PET, and is suitable as a replacement for the unmodified PET. Ambient light such as sunlight, fluorescent light, LED, flames, or incandescent light, does not provide enough energy to degrade the two-photon absorbing chromophore. Only high intensity light sources capable of delivering two photon excitation of the chromophore can provide enough energy to degrade the polymeric resin and permit separation and recovery of one or more components of the resin. The resins are exposed to high intensity light which depolymerizes them and allows for valuable chemical units and components such as monomers and small molecules to be reclaimed in pristine or near pristine condition. The reclaimed monomers can then be used to create new polymers with the physical properties that the original materials had. This is very advantageous over current recycling technologies where the polymer is difficult to depolymerize and the resulting recovered materials are greatly inferior in physical properties. The decomposable resins, and their reusable, decomposed products, have utility not only in the food packaging industry, but also in many industries where plastics are commonly used.

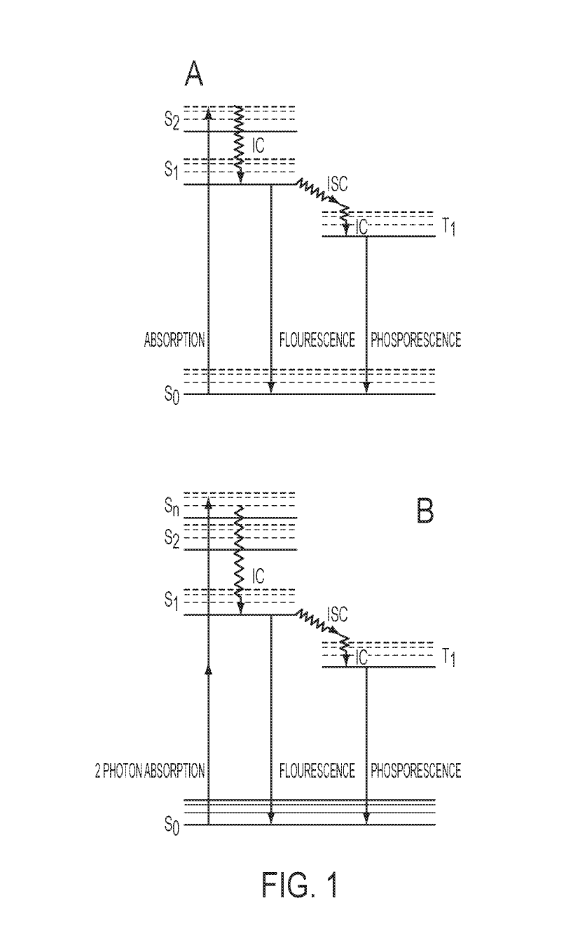

The two-photon absorbing chromophores described herein use a form of non-linear optics. FIG. 1 illustrates a simple absorption (one photon absorption) (FIG. 1A) and a two-photon absorption (FIG. 1B) process.

In FIG. 1A, the molecule at a ground state of S₀ absorbs a photon such that the molecule is at an excited state illustrated as singlet state S₂. Through internal conversion (IC) the molecular state relaxes to the lowest vibrational ground state, singlet state S₁. The compound can then return to the ground state S₀ through fluorescence, or transition by intersystem crossing (ISC) and internal conversion to a ground state of different spin multiplicity, for example, triplet state T₁. From T₁, the molecule can then return to S₀ through phosphorescence.

Certain aspects of non-linear optics include the ability of a molecule to absorb two quanta of energy simultaneously. FIG. 1B illustrates the absorption of two photons of energy to reach higher excited states followed by relaxation. For molecules that are able to absorb two photons, there is a weakly defined state between the ground state (S₀) and the first singlet excited state (S₁). The two-photon absorbing chromophore absorbs two photons simultaneously; one photon excites the chromophore to the weakly defined state and the other photon excites the chromophore to the first (S₁), second (S₂), or higher (Sₙ) excited singlet state. When the chromophore absorbs two photons it decomposes. The decomposition of the chromophore has the effect of reducing the molecular weight of the resin systems making them easier to recycle.

The two-photon absorbing chromophore described herein may be any two-photon absorbing chromophore known in the art. For example, in some embodiments, the two-photon absorbing chromophore may be represented by Formula I:

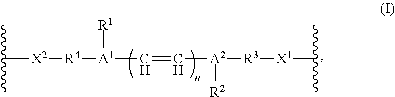

wherein A¹ may be aryl, heteroaryl, substituted aryl, cycloalkyl, heterocycloalkyl, methine, vinyl, substituted vinyl, aryl group fused to the bonded C atom, or cyclic compound fused to the bonded C atom.

In some embodiments, A² may be aryl, heteroaryl, substituted aryl, cycloalkyl, heterocycloalkyl, methine, vinyl, substituted vinyl, aryl group fused to the bonded C atom, or cyclic compound fused to the bonded C atom.

In some embodiments, R¹ may be —H, —C≡N, —OH, —O-alkyl, —C(═O)—OMe, —NH-alkyl, —N═N-alkyl, —CH═N-alkyl, —SH, —S-alkyl, —S(═O)-alkyl, —SO₂-alkyl, or —SO₃H.

In some embodiments, R² may be —H, —C≡N, —OH, —O-alkyl, —C(═O)—OMe, —NH-alkyl, —N═N-alkyl, —CH═N-alkyl, —SH, —S-alkyl, —S(═O)-alkyl, —SO₂-alkyl, or —SO₃H.

In some embodiments, R³ may be arylene, alkenylene, or a bivalent cyclic compound.

In some embodiments, R⁴ may be arylene, alkenylene, or a bivalent cyclic compound.

In some embodiments, X¹ may be B, C, N, Si, O, P, S, Se, or As.

In some embodiments, X² may be B, C, N, Si, O, P, S, Se, or As; and n is an integer from 1 to 20.

In other embodiments, the two-photon absorbing chromophore includes a moiety of Formula II:

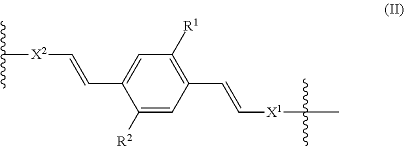

wherein R¹ may be —H, —C≡N, —OH, —O-alkyl, —C(═O)—OMe, —NH-alkyl, —N═N-alkyl, —CH═N-alkyl, —SH, —S-alkyl, —S(═O)-alkyl, —SO₂-alkyl, or —SO₃H. In some embodiments, R² may be —H, —C≡N, —OH, —O-alkyl, —C(═O)—OMe, —NH-alkyl, —N═N-alkyl, —CH═N-alkyl, —SH, —S-alkyl, —S(═O)-alkyl, —SO₂-alkyl, or —SO₃H. In some embodiments, X¹ may be B, C, N, Si, O, P, S, Se, or As; and X² may be B, C, N, Si, O, P, S, Se, or As.

In other embodiments, the two-photon absorbing chromophore includes a moiety of Formula III:

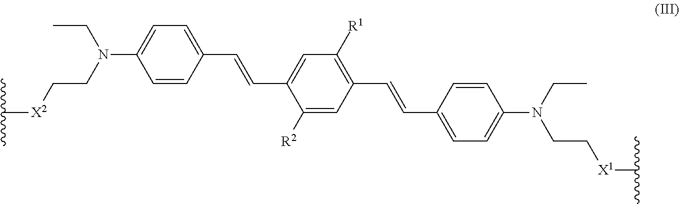

wherein R¹ may be —H, —C≡N, —OH, —O-alkyl, —C(═O)—OMe, —NH-alkyl, —N═N-alkyl, —CH═N-alkyl, —SH, —S-alkyl, —S(═O)-alkyl, —SO₂-alkyl, or —SO₃H. In some embodiments, R² may be —H, —C≡N, —OH, —O-alkyl, —C(═O)—OMe, —NH-alkyl, —N═N-alkyl, —CH═N-alkyl, —SH, —S-alkyl, —S(═O)-alkyl, —SO₂-alkyl, or —SO₃H. In some embodiments, X¹ may be B, C, N, Si, O, P, S, Se, or As; and X² may be B, C, N, Si, O, P, S, Se, or As.

In other embodiments, the two-photon absorbing chromophore includes a moiety of Formula IV:

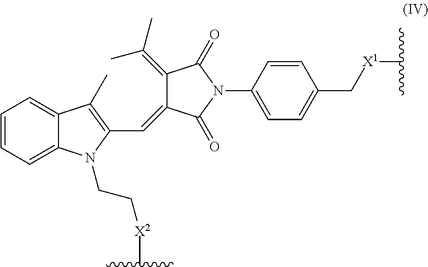

wherein X¹ may be B, C, N, Si, O, P, S, Se, or As; and X² may be B, C, N, Si, O, P, S, Se, or As.

In other embodiments, the two-photon absorbing chromophore includes a moiety of Formula V:

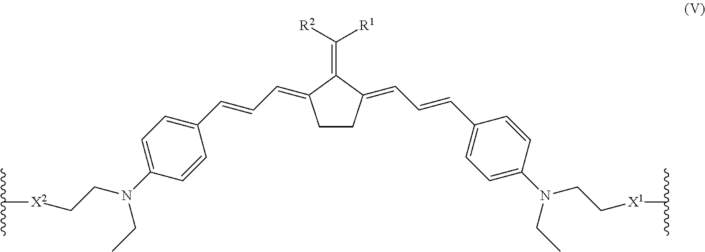

wherein R¹ may be —H, —C≡N, —OH, —O-alkyl, —C(═O)—OMe, —NH-alkyl, —N═N-alkyl, —CH═N-alkyl, —SH, —S-alkyl, —S(═O)-alkyl, —SO₂-alkyl, or —SO₃H. In some embodiments, R² may be —H, —C≡N, —OH, —O-alkyl, —C(═O)—OMe, —NH-alkyl, —N═N-alkyl, —CH═N-alkyl, —SH, —S-alkyl, —S(═O)-alkyl, —SO₂-alkyl, or —SO₃H. In some embodiments, X¹ may be B, C, N, Si, O, P, S, Se, or As; and X² may be B, C, N, Si, O, P, S, Se, or As.

Various polymer resins have the second repeating unit including, but are not limited to —C(═O)—Ar—C(═O)—CH₂—CH₂—O—, —C(═O)—NH—Ar—CH₂—Ar—NH—C(═O)—O—CH₂—CH₂—O—, —C(═O)—X₃—NH—, or —C(═O)—X₃—O—; wherein X₃=—CH((C₁-C₆)alkyl)-, —(CH₂)ₙ—, —Ar—C(═O)—NH—Ar—, or —(CH₂)ₙ—C(═O)—NH—(CH₂)ₘ—C(═O)—; m=2, 3, 4, 5, or 6; and n=2, 3, 4, 5, or 6. Various polymer resins have the second repeating unit including, but is not limited to R⁷—O—X₄—O—R⁷—O—, wherein: R⁷ is —CH₂—CHOH—CH₂—; and X₄ is —Ar—C(Me)₂-Ar—, —Ar—C(CF₃)₂—Ar—, a novolac resin, a phenol novolac resin, a cresol novolac resin, -alkylidene-, or combination thereof. In some embodiments, Ar is a 1,4-phenylene. In other embodiments, Ar is a 1,3-phenylene. In yet other embodiments, Ar is a 1,2-phenylene. Various polymer resins have the second repeating unit including, but is not limited to —CH₂—CR⁸R⁹—; wherein R⁸=H, or Me; R⁹=H, COOH, COOR¹⁰, CONR¹¹R¹², Ph, Cl, OAc, or Me; R¹⁰ is hydrogen, methyl, ethyl, propyl, or butyl; R¹¹ is hydrogen, or methyl; and R¹² is hydrogen, or methyl. Various polymer resins have the second repeating unit as an ether moiety including, but are not limited to, —(CH₂)ₙ—O—, —CH(Me)-CH₂—O—, —CH₂—CH(OH)—CH₂—O—, —CH(CH₂OH)—CH₂—O—, —CH₂—C(Me)₂-CH₂—O—, —CH₂—C(CH₂OH)₂—CH₂—O—, or combination thereof, wherein n=2, 3, 4, 5, or 6; and the resin further includes a third repeating unit, wherein the third repeating unit is —C(═NH)—Ar—C(═NH)—O—, —C(═O)—Ar—C(═O)—O—, —C(═O)—CH₂—CH₂—CH₂—CH₂—C(═O)—O—, or a combination thereof. In each of the above embodiments of the resin, the resin may be degradable upon a two-photon excitation of the chromophore.

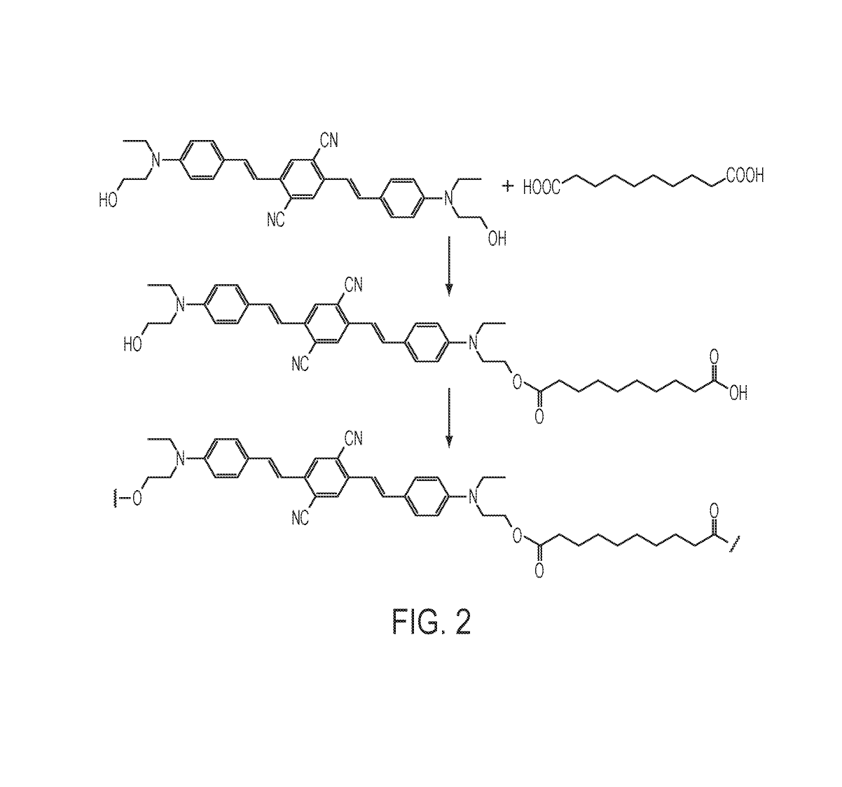

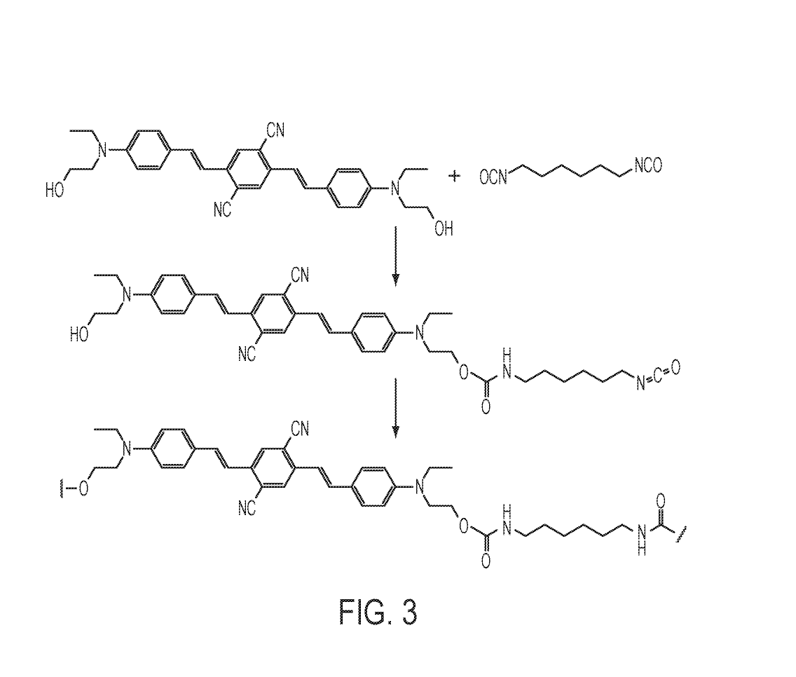

The two-photon absorbing chromophore can be adapted to a variety of chemical structures. An example of a two-photon absorbing chromophore is 2,5-bis-(2-{4-[ethyl-(2-hydroxy-ethyl)-amino]-phenyl}-vinyl)-terephthalonitrile (VIII). Other two-photon absorbing chromophores can also be used. The hydroxyl moieties in the chromophore can be used to form step growth condensation type polymers such as, but not limited to, polyesters, polyethers, or polyurethanes. FIG. 2 and FIG. 3 illustrate some representative step growth polymers that can be made.

In step growth polymerization, typically monomers with two functional groups are used. In FIG. 2, the first monomer is a diol having a two-photon absorbing chromophore, while the second monomer is a dicarboxylic acid. In polymerization, condensation of an alcohol of the first monomer and an acid of the second monomer forms an ester bond in addition to the generation of water. This dimer retains an alcohol moiety and a carboxylic acid moiety. The alcohol group can then react with the carboxylic acid moiety of another dimer to form tetramers and higher polymers. Similarly, in FIG. 3, the first monomer is a diol, while the second monomer is a diisocyanate. In the polymerization, condensation of an alcohol of the first monomer and an isocyanate of the second monomer forms a carbamate bond. This dimer retains an alcohol moiety and an isocyanate moiety. The alcohol moieties can react with isocyanates of other dimers to form tetramers and higher polymers.

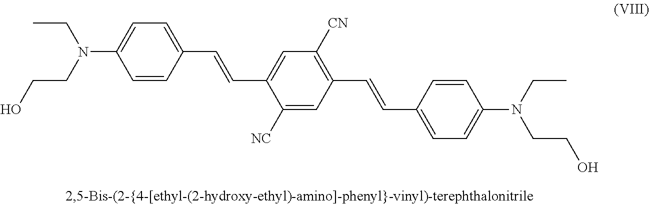 [SMILES: CCN(CCO)c1ccc(/C=C/c2cc(C#N)c(/C=C/c3ccc(N(CC)CCO)cc3)cc2C#N)cc1]

The two-photon absorbing chromophore 2,5-Bis-(2-{4-[ethyl-(2-hydroxy-ethyl)-amino]-phenyl}-vinyl)-terephthalonitrile (VIII) can form other monomers by replacing the hydroxyl moieties with functional moieties such as acrylic, styrenic, or vinylic moieties. Amine moieties can also be used to replace the hydroxyl moieties, which can then form polyamides or acrylamides. These functional two-photon absorbing chromophores can be used in chain growth systems such as ethylene, propylene, acrylic, styrene, vinyl acetates, vinyl chlorides and the like. Epoxy and urethane systems can be created by using glycidyl and isocyanates with the chromophore.

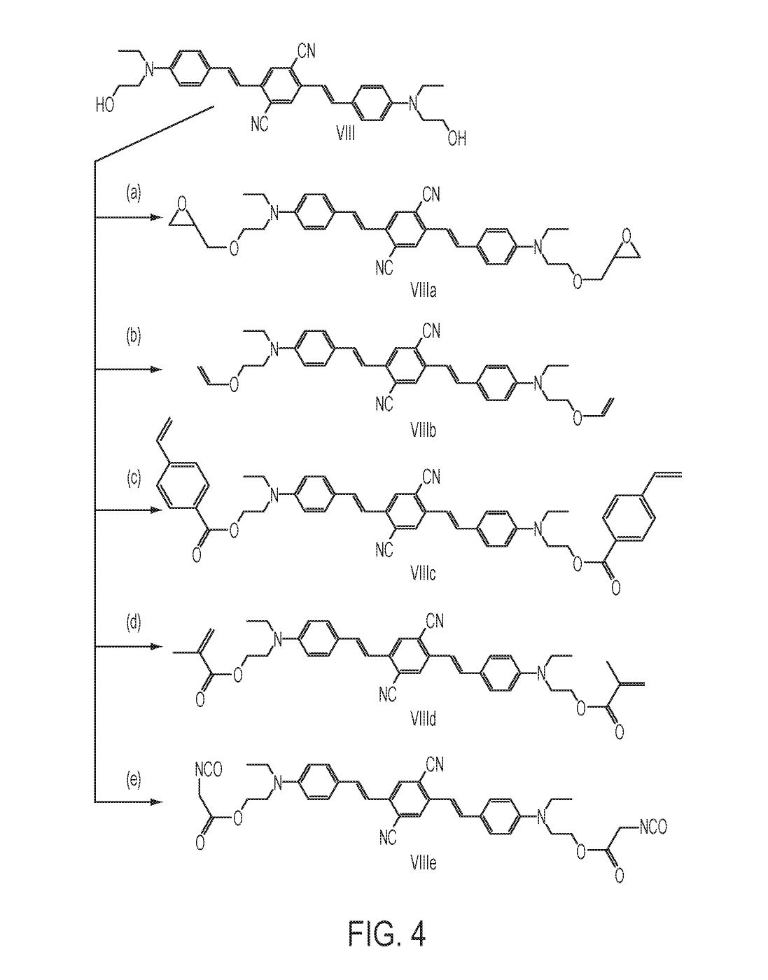

FIG. 4a shows the diol two-photon absorbing chromophore (VIII) may be converted to a diglycidyl ether monomer (VIIIa). FIG. 4b shows diol (VIII) converted to a divinyl ether monomer (VIIIb). FIG. 4c shows diol (VIII) converted to a bis-vinylbenzoate ester monomer (VIIIc). FIG. 4d shows diol (VIII) converted to a dimethacrylate ester monomer (VIIId). FIG. 4e shows diol (VIII) converted to a bis-isocyanate ester monomer (VIIIe).

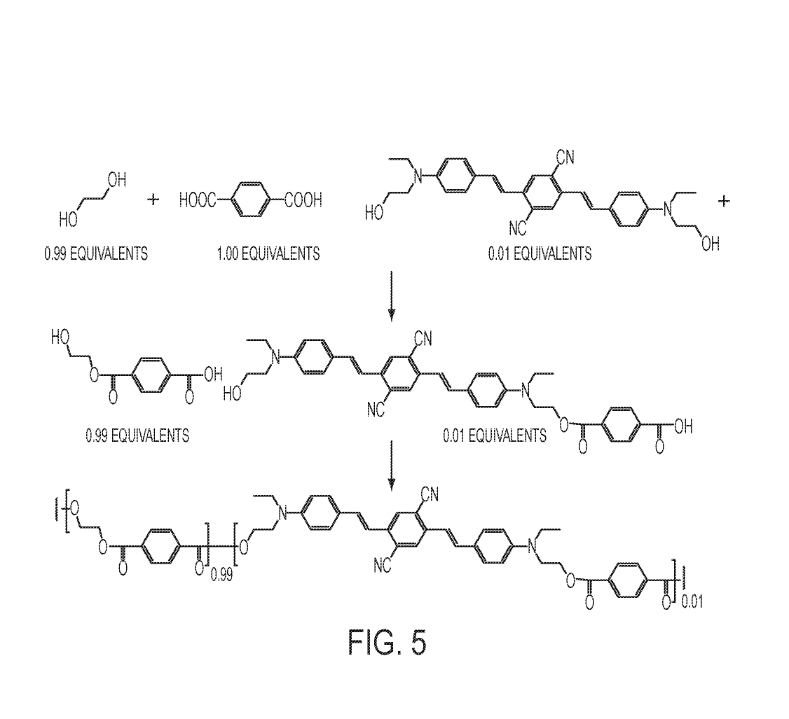

FIG. 5 illustrates an exemplary reaction to form a two-photon absorbing chromophore containing polyethylene terephthalate (PET) polymer. PET polymers are commonly made from the monomers terephthalic acid and ethylene glycol. As depicted in FIG. 5, a small amount of a first monomer, for example ethylene glycol, may be replaced by a two-photon absorbing chromophore monomer having similar functional group moieties. The second monomer, for example terephthalic acid, will thus form a polymer incorporating the first monomer and the small amount of the two-photon absorbing monomer. Polymers containing the two-photon absorbing chromophore can be decomposed by exposure to high-intensity incident light. The polymers can be exposed to a high intensity light source, such as a laser or a cross section of two low powered lasers. While lasers are required for 2-photon excitation of the chromophore, the lasers need not be elaborate or expensive. Simple diode lasers can be adequate for the 2-photon excitation. Diode lasers can come in a variety of beam widths and can depolymerize large sections of the polymer in each exposure. The incident beam of the laser can have approximately twice the energy of the main absorption band of the chromophore. The incident beam can be narrow (1-10 nm) or wide (inches). To induce decomposition, an article made from the two-proton chromophore containing resin can be exposed to the incident light. The light causes the chromophore sites along the polymer backbone to disintegrate leading to breakdown of the polymer into polymer fragments. The polymer fragments can be recycled to form new polymers or other high valued materials.

Some embodiments provide a polymer resin having a polymeric backbone, wherein at least portion of the backbone includes a two-photon absorbing chromophore. In some embodiments, the polymer resin has an equimolar quantity of a first repeating unit and a second repeating unit, wherein the first repeating unit has a two-photon absorbing chromophore in the polymeric backbone. In other embodiments, the first repeating unit is about 5%, about 3%, about 2%, about 1%, about 0.5%, about 0.2%, about 0.1%, about 0.05%, about 0.01%, and ranges between any two of these values including endpoints, as a molar percentage of the second repeating unit.

Some embodiments provide a recyclable material having a polymer resin with a polymeric backbone, the polymer resin having a first repeating unit and a second repeating unit, wherein the first repeating unit has a two-photon absorbing chromophore in the polymeric backbone. In various embodiments, the recyclable material is configured for use in packaging, coatings, electronic components, adhesives or a combination thereof.

Some embodiments of the various recyclable materials further include at least one binder selected from an alkyd resin, acrylic resin, vinyl-acrylic resin, vinyl acetate/ethylene resin, polyurethane resin, polyester resin, melamine resin, epoxy resin, an oil, polyether resin, novolac resin, nylon, polyamide resin, styrenic resin, polyimide resin, polyamide-imide resin, and combinations thereof.

The recyclable material may have a two-photon absorbing chromophore in the polymeric backbone, and two-photon absorbing chromophore described herein may be any two-photon chromophore known in the art. In some embodiments, the recyclable material may have a two-photon absorbing chromophore in the polymeric backbone having a moiety of Formula I. In some embodiments, the recyclable material may also have a two-photon absorbing chromophore in the polymeric backbone having a moiety of Formula II. In some embodiments, the recyclable material may also have a two-photon absorbing chromophore in the polymeric backbone having a moiety of Formula III. In some embodiments, the recyclable material may also have a two-photon absorbing chromophore in the polymeric backbone having a moiety of Formula IV. In some embodiments, the recyclable material may also have a two-photon absorbing chromophore in the polymeric backbone having a moiety of Formula V. In some embodiments, the recyclable material may have a two-photon absorbing chromophore in the polymeric backbone, the two-photon absorbing chromophore having one or more moieties represented by Formulae I-V, or any combinations thereof.

In various embodiments, the recyclable material may have the two-photon absorbing chromophore present in the polymer resin in an amount of not more than 2% by weight.

Various recyclable material may have the second repeating unit including, but is not limited to, —(CH₂)n-O—, —CH(Me)-CH₂—O—, —CH₂—CH(OH)—CH₂—O—, —CH(CH₂OH)—CH₂—O—, —CH₂—C(Me)₂-CH₂—O—, —CH₂—C(CH₂OH)₂—CH₂—O—, or a combination thereof, wherein n=2-6; and the polymer resin further includes a third repeating unit, the third repeating unit including, but is not limited to, —C(═O)—Ar—C(═O)—O—, —C(═O)—CH₂—CH₂—CH₂—CH₂—C(═O)—O—, or a combination thereof.

Various embodiments of the recyclable materials may have the second repeating unit including, but is not limited to, —C(═O)—Ar—C(═O)—CH₂—CH₂—O—, —C(═O)—NH—Ar—CH₂—Ar—NH—C(═O)—O—CH₂—CH₂—O—, —C(═O)—X₃—NH—, or —C(═O)—X₃—O—; wherein X₃=—CH((C₁-C₆)alkyl)-, —(CH₂)n-, —Ar—C(═O)—NH—Ar—, or —(CH₂)n-C(═O)—NH—(CH₂)m-C(═O)—, and wherein m=2, 3, 4, 5, or 6; and n=2, 3, 4, 5, or 6. In other embodiments, the recyclable material may have the second repeating unit including, but is not limited to, —(CH₂)n-O—, —CH(Me)-CH₂—O—, —CH₂—CH(OH)—CH₂—O—, —CH(CH₂OH)—CH₂—O—, —CH₂—C(Me)₂-CH₂—O—, —CH₂—C(CH₂OH)₂—CH₂—O—, or combination thereof wherein n=2-6; and the polymer resin may further include a third repeating unit, wherein the third repeating unit is —C(═NH)—Ar—C(═NH)—O—. In still other embodiments, the recyclable material may have the second repeating unit including, but is not limited to, —R⁷—O—X₄—O—R⁷—O—, wherein: R⁷ is —CH₂—CHOH—CH₂—; and X₄ is —Ar—C(Me)₂-Ar—, —Ar—C(CF₃)₂—Ar—, a novolac resin, a phenol novolac resin, a cresol novolac resin, -alkylidene-, or combination thereof. In the various embodiments, Ar may be a 1,4-phenylene. In other embodiments, Ar may be a 1,3-phenylene. In still other embodiments, Ar may be a 1,2-phenylene.

Various embodiments of the recyclable material may have a second repeating unit that includes —CH₂—CR⁸R⁹—, wherein R⁸=H, or Me; R⁹=H, COOH, COOR¹⁰, CONR¹¹R¹², Ph, Cl, OAc, or Me; R¹⁰ is hydrogen, methyl, ethyl, propyl, or butyl; R¹¹ is hydrogen, or methyl; and R¹² is hydrogen, or methyl.

Each of the various embodiments of the recyclable material may degrade upon a two-photon excitation.

Disclosed are methods of preparing a polymer resin. The methods include polymerizing a first monomer and a second monomer, wherein the first monomer has a two-photon absorbing chromophore which is incorporated into a backbone of the polymer resin. Any suitable two-proton absorbing chromophore known in the art may be used. In some methods, the two-photon absorbing chromophore includes a moiety of Formula VI:

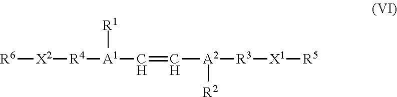

wherein A¹ may be aryl, heteroaryl, substituted aryl, cycloalkyl, heterocycloalkyl, methine, vinyl, substituted vinyl, aryl group fused to the bonded C atom, or cyclic compound fused to the bonded C atom.

In some embodiments, A² may be aryl, heteroaryl, substituted aryl, cycloalkyl, heterocycloalkyl, methine, vinyl, substituted vinyl, aryl group fused to the bonded C atom, or cyclic compound fused to the bonded C atom;

In some embodiments, R¹ may be —H, —C≡N, —OH, —O-alkyl, —C(═O)—OMe, —NH-alkyl, —N═N-alkyl, —CH═N-alkyl, —SH, —S-alkyl, —S(═O)-alkyl, —SO₂-alkyl, or —SO₃H. R² may be —H, —C≡N, —OH, —O-alkyl, —C(═O)—OMe, —NH-alkyl, —N═N-alkyl, —CH═N-alkyl, —SH, —S-alkyl, —S(═O)-alkyl, —SO₂-alkyl, or —SO₃H;

In some embodiments, R³ may be arylene, alkenylene, or a bivalent cyclic compound. R⁴ may be arylene, alkenylene, or a bivalent cyclic compound;

In some embodiments, X¹ may be B, C, N, Si, O, P, S, Se, or As. X² may be B, C, N, Si, O, P, S, Se, or As;

In some embodiments, R⁵ may be a hydrogen, an alkylene, a substituted alkylene, an unsaturated ester, an alkylene substituted —C(═O)-Ph, an alkylene oxide, or an acyl isocyanate;

In some embodiments, R⁶ may be a hydrogen, an alkylene, a substituted alkylene, an unsaturated ester, an alkylene substituted —C(═O)-Ph, an alkylene oxide, or an acyl isocyanate; and n is an integer from 1 to 20.

In some embodiments, R⁵ may be —H; —CH═CH₂; —C(CH₃)═CH₂; —CO—CH═CH₂; —CO—C(CH₃)═CH₂; —CO—C₆H₄—CH═CH₂; —CO—C₆H₄—C(CH₃)═CH₂; —CH₂—CH(CH₂)O; —CO—CH₂NCO; —C(Cl)═CH₂; or —C(OAc)═CH₂.

In some embodiments, R⁶ may be —H; —CH═CH₂; —C(CH₃)═CH₂; —CO—CH═CH₂; —CO—C(CH₃)═CH₂; —CO—C₆H₄—CH═CH₂; —CO—C₆H₄—C(CH₃)═CH₂; —CH₂—CH(CH₂)O; —CO—CH₂NCO; —C(Cl)═CH₂; or —C(OAc)═CH₂.

In some methods, the two-photon absorbing chromophore includes a moiety of Formula VII:

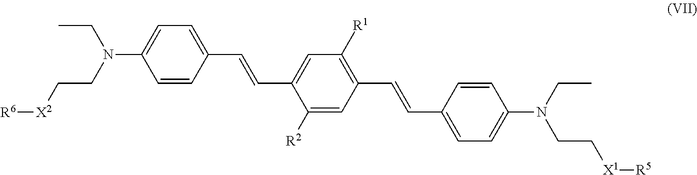

wherein R¹ is —H, —C≡N, —OH, —O-alkyl, —C(═O)—OMe, —NH-alkyl, —N═N-alkyl, —CH═N-alkyl, —SH, —S-alkyl, —S(═O)-alkyl, —SO₂-alkyl, or —SO₃H.

In some embodiments, R² may be —H, —C≡N, —OH, —O-alkyl, —C(═O)—OMe, —NH-alkyl, —N═N-alkyl, —CH═N-alkyl, —SH, —S-alkyl, —S(═O)-alkyl, —SO₂-alkyl, or —SO₃H.

In some embodiments, R⁵ may be hydrogen; an alkylene; a substituted alkylene; an unsaturated ester; an alkylene substituted —C(═O)-Ph; an alkylene oxide; or an acyl isocyanate.

In some embodiments, R⁶ may be hydrogen; an alkylene; a substituted alkylene; an unsaturated ester; an alkylene substituted —C(═O)-Ph; an alkylene oxide; or an acyl isocyanate.

In some embodiments, X¹ may be B, C, N, Si, O, P, S, Se, or As; and X² is B, C, N, Si, O, P, S, Se, or As.

Exemplary two-photon absorbing chromophores of formula VII may include:

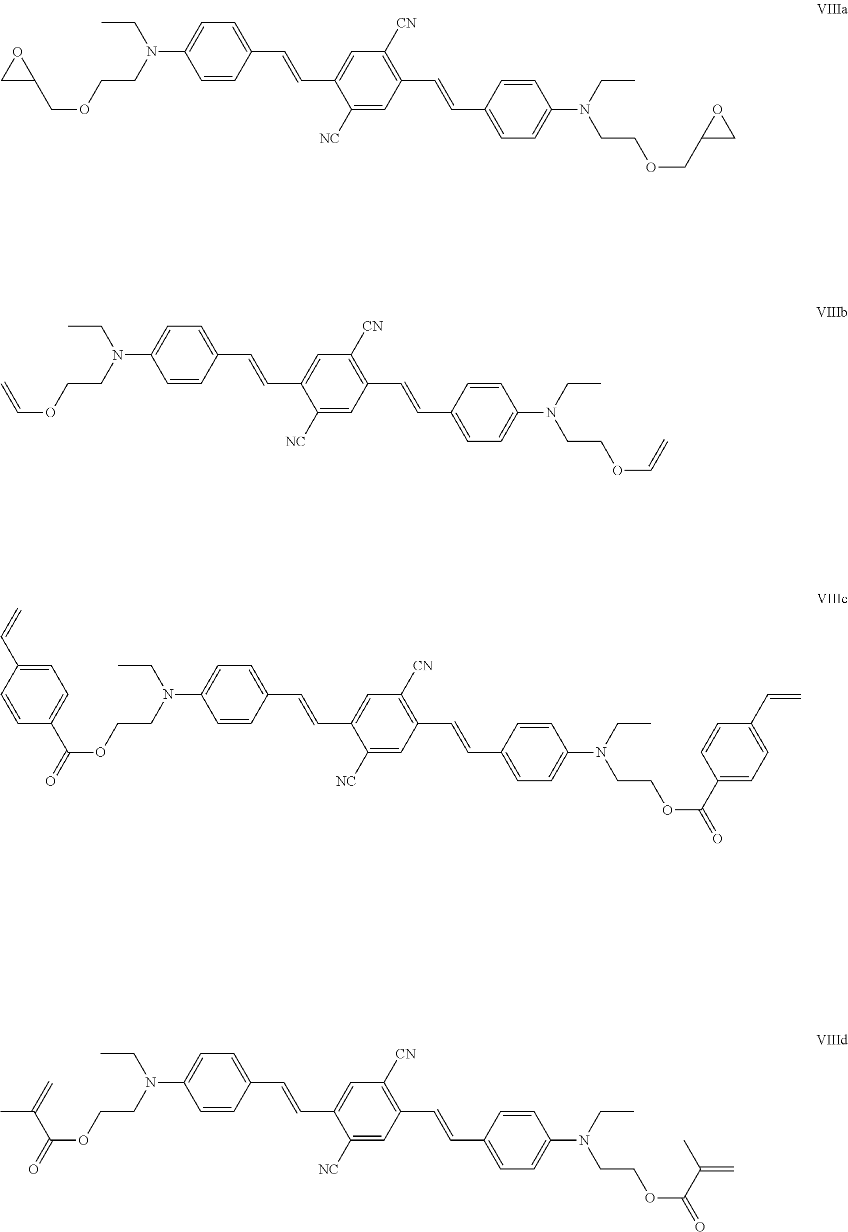

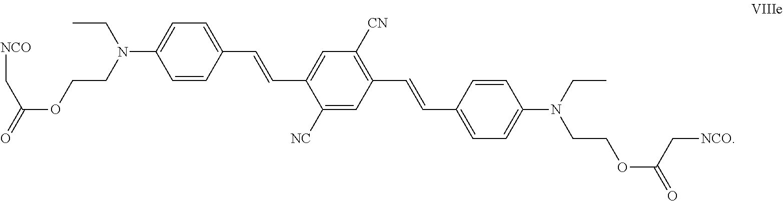

In various methods, R⁵ and R⁶ are hydrogen, and the second monomer includes ethylene glycol, 1,4-butanediol, 1,2-propanediol, 1,3-propanediol, propylene glycol, glycerol, neopentyl glycol, trimethylol propane, hexanediol, or a combination thereof, and the polymerizing step further includes polymerizing a third monomer with the first and second monomers, wherein the third monomer includes terephthalic acid, isophthalic acid, orthophthalic acid, phthalic anhydride, hexanedioic acid, or a combination thereof. In other methods, R⁵ and R⁶ are hydrogen, the second monomer contains terephthalic acid; and the polymerizing step further includes polymerizing a third monomer with the first and second monomers, wherein the third monomer includes ethylene glycol, 1,4-butanediol, 1,2-propanediol, 1,3-propanediol, glycerol, neopentyl glycol, trimethylol propane, or a combination thereof.

In various methods, the second monomer may include but is not limited to, acrylic acid, methacrylic acid, methyl acrylate, methyl methacrylate, ethyl methacrylate, propyl methacrylate, butyl methacrylate, diglycidyl ether, bisphenol A diglycidyl ether, bisphenol F diglycidyl ether, epoxidized novolac, epoxy phenol novolac, epoxy cresol novolac, aliphatic diglycidyl ether, glycidylamine epoxide, or a combination thereof. In yet other methods, the second monomer includes, but is not limited to, polystyrene, polyethylene, polyvinyl, polyacrylate, poly(ethylene terephthalate), polyvinylchloride, polypropylene, polyvinyl acetate, polyester, polyamide, polyacrylamide, polyepoxide, polyurethane, or a combination thereof. In still another method, the second monomer includes, but is not limited to, styrene, ethylene, propylene, or a combination thereof; and R⁵ and R⁶ are independently selected from —CH═CH₂; —C(CH₃)═CH₂; —CO—C₆H₄—CH═CH₂; —CO—C₆H₄—C(CH₃)═CH₂; —C(Cl)═CH₂; and —C(OAc)═CH₂. In still other methods, the second monomer includes, but is not limited to, an acrylate, methacrylate, or a combination thereof; and R⁵ and R⁶ are independently selected from —CO—CH═CH₂; —CO—C(CH₃)═CH₂; or a combination thereof. In yet other methods, the second monomer includes, but is not limited to, a diisocyanate; R⁵ and R⁶ are each —CO—CH₂NCO; and the polymerizing further includes polymerizing a third monomer with the first and second monomers, wherein the third monomer includes ethylene glycol, 1,4-butanediol, 1,2-propanediol, 1,3-propanediol, glycerol, neopentyl glycol, trimethylol propane, or a combination thereof. In another method, the second monomer is diglycidyl ether; and R and R¹ are each —CH₂—CH(CH₂)O. In yet another method, the second monomer includes, but is not limited to, bisphenol A diglycidyl ether, bisphenol F diglycidyl ether, epoxidized novolacs, epoxy phenol novolacs, epoxy cresol novolacs, aliphatic diglycidyl ethers, glycidylamine epoxides, or a combination thereof.

In any of the embodiments of the methods of preparing a polymer resin, the first monomer may be present in the resin in an amount of no more than 5% by weight. In other embodiments, the first monomer may be present in the resin in an amount of no more than 2% by weight. In still other embodiments, the first monomer may be present in the resin in an amount of no more than 1% by weight of the resin. In yet another embodiment, the first monomer may be present in the resin in an amount of no more than 0.5% by weight.

Also disclosed are methods of degrading a polymer, the methods include exposing the polymer to light, the polymer having a first repeating unit and a second repeating unit, wherein the first repeating unit has a two-photon absorbing chromophore in a polymeric backbone of the polymer. The two-photon absorbing chromophore disclosed herein may be any two-photon absorbing chromophore known in the art. In some embodiments, the two-photon absorbing chromophore has Formula I. In some embodiments, the two-photon absorbing chromophore has Formula II. In other embodiments, the two-photon absorbing chromophore has Formula III. In some embodiments, the two-photon absorbing chromophore has Formula IV. In some embodiments, the two-photon absorbing chromophore has Formula V. In some embodiments, the two-photon absorbing chromophore may be one or more structures represented by Formulae I-V, or any combinations thereof.

In the various methods, the resin may degrade upon a two-photon excitation. In some methods, exposing the polymer to light includes exposing the polymer to high-intensity light. In some embodiments, exposing the polymer to light includes exposing the polymer to a cross section of light from two lasers. In other embodiments, exposing the polymer to light includes exposing the polymer to light from a diode laser.

While lasers may be used for this process, excitation of 2-photon chromophores does not require elaborate and expensive lasers. Diode lasers are more than sufficient for the process.

These technologies and embodiments illustrating the method and materials used may be further understood by reference to the following non-limiting examples.

### EXAMPLES

### Example 1

### Preparation of 2,5-Bis-(2-{4-ethyl-(2-hydroxy-ethyl)-aminol-phenyl}-vinyl)terephthalonitrile (VIII)

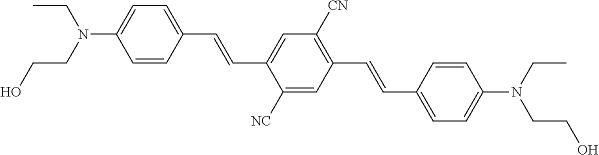 [SMILES: CCN(CCO)c1ccc(/C=C/c2cc(C#N)c(/C=C/c3ccc(N(CC)CCO)cc3)cc2C#N)cc1]

### Preparation of 1,4-Bis(bromomethyl)-3,6-dicyanobenzene

A solution of 1,4-dicyano-3,6-dimethylbenzene (21 grams, 0.13 mol) and Br₂ (40 grams, 0.25 mol) in CCl₄ (1.0 L) is irradiated with 400 W tungsten lamp for 12 hours. After removing the unreacted Br₂ with Na₂S₂O₃ (aq), the product is extracted with CH₂Cl₂ and purified on a silica column using hexane/ethyl acetate (30:1, by volume) as eluent to obtain yellow solid. Yield: 14 grams (34%).

### Preparation of 1,4-Bis(diethoxyphosphorylmethyl)-3,6-dicyanobenzene

A solution of 1,4-bis(bromomethyl)-3,6-dicyanobenzene (13 grams, 41 mmol) prepared above and P(OEt)₃ (29 grams, 0.25 mol) in toluene (200 mL) is refluxed for 5 hours. The solvent is removed in vacuo and the product is purified on a silica column using ethyl acetate/methanol (10:1, by volume) as eluent to obtain yellow solid. Yield: 15 grams (85%).

### Preparation of Benzaldehyde,4-[[2-[[(1,1-dimethylethyl)dimethylsilyl]oxy]-ethyl]ethylamino]-

To a cooled solution of 4-[ethyl-(2-hydroxy-ethyl)-amino]-benzaldehyde (0.49 mmol) in 20 mL of methylene chloride under the nitrogen, 1.5 mL of bromotrimethylsilane is added dropwise. The reaction mixture is stirred at −20° C. for 2.5 hours, and then neutralized with 50 mL of saturated aqueous sodium bicarbonate solution. The residue is partitioned between water and methylene chloride and extracted. The combined extracts are dried over sodium sulfate. The crude product is purified by column chromatography using ethyl acetate and hexane (3:2, by volume) to obtain the product (yield: 83%).

### Preparation of 2,5-Bis-(2-{4-[(tert-butyl-dimethyl-silanyloxyethyl)-ethyl-amino]-phenyl}-vinyl)-terephthalonitrile

Lithium diisopropylamide (1.5 M, 12 mL) is slowly added to a stirred solution of above prepared 1,4-bis(diethoxyphosphorylmethyl)-3,6-dicyanobenzene (3.3 grams, 7.7 mmol) in THF (80 mL) at 0° C. After stirring the mixture for 30 minutes, a solution of benzaldehyde, 4-[[2-[[(1,1-dimethylethyl)dimethylsilyl]oxy]ethyl]-ethylamino]- (0.80 grams, 2.6 mmol) in THF (20 mL) is added slowly and stirred for 1 day. The solvent was evaporated and the product is purified on a silica column using hexane/ethyl acetate (2:3, by volume) as eluent.

The t-butyldimethylsilyl protecting groups from 2,5-Bis-(2-{4-[(tert-butyl-dimethyl-silanyloxyethyl)-ethyl-amino]-phenyl}-vinyl)-terephthalonitrile are removed by refluxing in acetone/H₂O (95:5, by volume) containing 5 mmol % of CuCl₂.2H₂O to obtain compound VIII.

### Example 2

### Preparation of Monomer VIIIa, 2,5-bis(4-(ethyl(2-(oxiran-2-ylmethoxy)ethyl)amino)styryl)terephthalonitrile

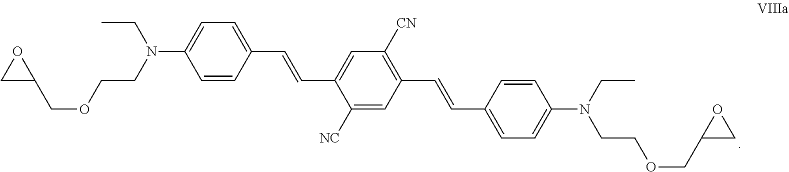 [SMILES: CCN(CCOCC1CO1)c1ccc(/C=C/c2cc(C#N)c(/C=C/c3ccc(N(CC)CCOCC4CO4)cc3)cc2C#N)cc1]

Synthesis of monomer 2,5-bis(4-(ethyl(2-(oxiran-2-ylmethoxy)ethyl)amino)-styryl)terephthalonitrile, (VIIIa) includes mixing compound VIII (1.35 grams, 2.7 mmol), 5 mL of dioxane, and 2 microliters of boron trifluoride ethyl etherate solution (45 weight % boron trifluoride), and heating the mixture to 65° C. Epichlorohydrin (0.6 grams) is added to the mixture. The mixture is stirred for an hour at 60-87° C. and sodium aluminate (0.1 grams) is added. The mixture is refluxed for about 8 hours, and then filtered. The filtrate is concentrated to yield the monomer VIIIa.

### Example 3

### Preparation of Monomer VIIIb, 2,5-bis(4-(ethyl(2 (vinyloxy)ethyl)amino)-styryl)-terephthalonitrile

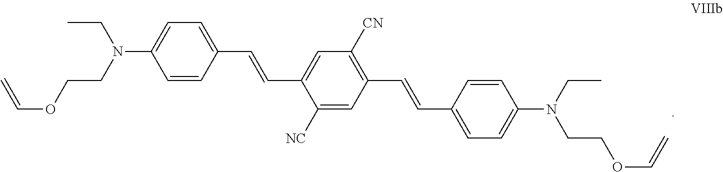 [SMILES: C=COCCN(CC)c1ccc(/C=C/c2cc(C#N)c(/C=C/c3ccc(N(CC)CCOC=C)cc3)cc2C#N)cc1]

Synthesis of the monomer 2,5-bis(4-(ethyl(2-(vinyloxy)ethyl)amino)-styryl)terephthalonitrile, (VIIIb) includes mixing 20 mL of methylene chloride, 0.5 grams (7.14 mmoles) divinyl ether, compound VIII prepared as in Example 1 (1.8 grams, 3.6 mmol), and 0.1 grams red mercuric oxide. The mixture is stirred and trifluoroacetic acid (100 microliters) is added to the mixture as it is being stirred. The mixture is refluxed under a water cooled reflux condensor and desiccant drying tube. The methylene chloride solvent is removed in vacuo. The residue is dissolved in carbon tetrachloride and eluted with 35 mL of carbon tetrachloride through 2.5 grams neutral alumina (pH 7.3). The carbon tetrachloride is removed in vacuo to yield Monomer VIIIb.

### Example 4

### Preparation of Monomer VIIIc, 2,2′-(4,4′-(1E,1′E)-2,2′-(2,5-dicyano-1,4-phenylene)bis(ethene-2,1-diyl)bis(4,1-phenylene))bis(ethylazanediyl)bis(ethane-2,1-diyl) bis(4-vinylbenzoate)

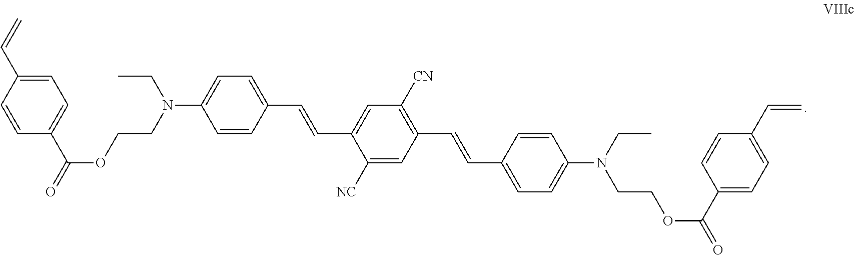 [SMILES: C=Cc1ccc(C(=O)OCCN(CC)c2ccc(/C=C/c3cc(C#N)c(/C=C/c4ccc(N(CC)CCOC(=O)c5ccc(C=C)cc5)cc4)cc3C#N)cc2)cc1]

Synthesis of the monomer 2,2′-(4,4′-(1E,1′E)-2,2′-(2,5-dicyano-1,4-phenylene)bis(ethene-2,1-diyl)bis(4,1-phenylene))bis(ethylazanediyl)bis(ethane-2,1-diyl) bis(4-vinylbenzoate) (VIIIc) includes mixing 4-vinybenzoyl chloride (1.0 grams, 6.3 mmol) in tetrahydrofuran (5 mL), and adding the mixture dropwise over 10 minutes to a mixture of compound VIII (1.35 grams, 2.7 mmol) prepared as in Example 1, triethylamine (0.55 grams, 5.4 mmol) and tetrahydrofuran (25 mL). The mixture is stirred at 20° C. for 21 hours. The mixture is poured into ice-cooled water (25 mL) and stirred for 3 hours. The tetrahydrofuran is removed in vacuo. Methylene chloride is added to the mixture form a separated layer of the chloride in the mixture. The methylene chloride phase is washed twice with dilute aqueous sodium bicarbonate (25 mL each) and once with saturated sodium chloride aqueous solution (25 mL). The methylene chloride phase is dried with sodium sulfate. The mixture is filtered and the solvents are removed in vacuo to obtain compound VIIIc.

### Example 5

### Preparation of Monomer VIIId, 2,2′-(4,4′-(1E,1′E)-2,2′-(2,5-dicyano-1,4-phenylene)bis(ethene-2,1-diyl)bis(4,1-phenylene))bis(ethylazanediyl)bis(ethane-2,1-diyl) bis(2-methylacrylate)

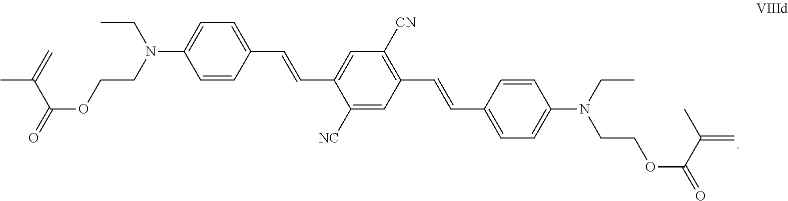 [SMILES: C=C(C)C(=O)OCCN(CC)c1ccc(/C=C/c2cc(C#N)c(/C=C/c3ccc(N(CC)CCOC(=O)C(=C)C)cc3)cc2C#N)cc1]

Synthesis of 2,2′-(4,4′-(1E,1′E)-2,2′-(2,5-dicyano-1,4-phenylene)bis(ethene-2,1-diyl)bis(4,1-phenylene))bis(ethylazanediyl)bis(ethane-2,1-diyl) bis(2-methylacrylate) (VIIId) includes mixing methacrylic anhydride (0.91 grams, 6.3 mmol) in anhydrous tetrahydrofuran (5 mL) and adding the mixture dropwise over 10 minutes to a mixture of compound VIII (1.35 grams, 2.7 mmol) prepared as in Example 1, triethylamine (1.00 grams, 9.9 mmol), and tetrahydrofuran (25 mL). The mixture is stirred at 20° C. for 21 hours. The mixture is poured into ice-cooled water (25 mL). The mixture is stirred for 3 hours. The tetrahydrofuran is removed in vacuo. Methylene chloride is added to the mixture (3×50 mL), shaken vigorously, and forms a separated layer of the methylene chloride in the mixture. The methylene chloride phase is washed twice with dilute aqueous sodium bicarbonate (25 mL each) and once with saturated sodium chloride aqueous solution (25 mL). The methylene chloride phase is dried with sodium sulfate. The resulting solids are loaded onto a packed silica column and chromatographed using ethyl acetate:hexane (3:1, by volume). The solvents are removed in vacuo to obtain compound VIIId.

### Example 6

### Preparation of Monomer VIIIe, 2,2′-(4,4′-(1E,1′E)-2,2′-(2,5-dicyano-1,4-phenylene)bis(ethene-2, 1-diyl)bis(4,1-phenylene))bis(ethylazanediyl)bis(ethane-2,1-diyl) bis(2-isocyanatoacetate)

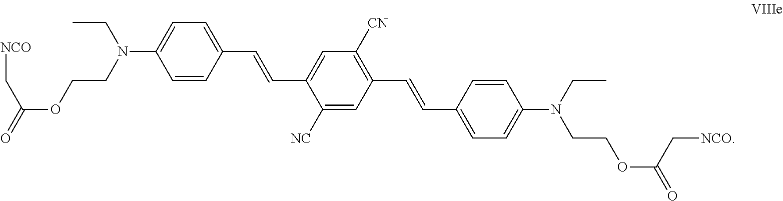

Synthesis of the monomer 2,2′-(4,4′-(1E,1′E)-2,2′-(2,5-dicyano-1,4-phenylene)bis(ethene-2,1-diyl)bis(4,1-phenylene))bis(ethylazanediyl)bis(ethane-2,1-diyl) bis(2-isocyanatoacetate) (VIIIe) includes the following: 1.47 mL of compound VIII (4.0 grams, 7.5 mmoles) prepared as in Example 1, dimethylaniline (2.12 mL, 2.02 grams, 16.7 mmoles), and diethyl ether are mixed, and the mixture is heated to reflux. Acetyl chloride (1.13 mL, 1.24 grams, 15.8 mmoles) is added to the mixture. The mixture is heated for an hour. The mixture is cooled to 20° C. Water (approximately 2 mL) is added to the mixture. The mixture is stirred until the solid materials dissolve. An ether layer is separated from the mixture and extracted with cold 10% sulfuric acid. The ether layer is washed with a saturated sodium bicarbonate solution. The ether solution is dried with anhydrous sodium sulfate. The solvents are removed in vacuo to yield a chloroacetate 2,2′-(4,4′-(1E,1′E)-2,2′-(2,5-dicyano-1,4-phenylene)bis(ethene-2, 1-diyl)bis(4,1-phenylene))bis(ethyl-azanediyl)bis(ethane-2,1-diyl) bis(2-chloroacetate).

Sodium azide and acetone are added to the chloroacetate prepared above. The mixture is heated and the acetone is distilled from the mixture. Water is added and the aqueous layer is extracted with ether. The ether solvents are removed in vacuo to obtain an azidoacetate 2,2′-(4,4′-(1E,1′E)-2,2′-(2,5-dicyano-1,4-phenylene)bis(ethene-2,1-diyl)bis(4,1-phenylene))bis(ethylazanediyl)bis(ethane-2,1-diyl) bis(2-azidoacetate).

The azidoacetate is mixed in methanol, and is reduced with 5 weight % palladium on charcoal catalyst and hydrogen gas. The hydrogen gas is displaced with nitrogen. The catalyst is removed by filtration. The catalyst is washed with methanol and the methanol combined with the reduced aminoacetate in methanol. The combined methanols are dried with sodium sulfite. The methanol solution is concentrated in vacuo to obtain an aminoacetate 2,2′-(4,4′-(1E,1′E)-2,2′-(2,5-dicyano-1,4-phenylene)bis(ethene-2,1-diyl)bis(4,1-phenylene))bis(ethyl-azanediyl)bis-(ethane-2,1-diyl) bis(2-aminoacetate).

The aminoacetate is converted to an isocyanate by reacting with thionyl chloride to yield the N-sulfinylacetate. The N-sulfinyl acetate is reacted with phosgene to yield the monomer VIIIe 2,2′-(4,4′-(1E,1′E)-2,2′-(2,5-dicyano-1,4-phenylene)bis(ethene-2,1-diyl)bis(4,1-phenylene))bis (ethyl-azane-diyl)bis(ethane-2,1-diyl) bis(2-isocyanatoacetate).

### Example 7

### Preparation of PET-Based Degradable Plastic

Terephthalic acid (one hundred parts), ethylene glycol (99 parts), and compound VIII (1 part) prepared as in Example 1, cobalt chloride (0.02 part), phosphorous acid (0.04 part), and antimony oxide (0.02 part) are mixed. The mixture is heated at atmospheric pressure, and then under high pressure to obtain a polyethylene terephthalate (PET)-based degradable plastic. The reaction sequence is illustrated as FIG. 5.

### Example 8

### Preparation of Polyglycidyl Ethyl Ether Degradable Plastic

1,4-Butanediol (0.3 grams, 3.5 mmol) and boron trifluoride etherate (0.5 grams, 3.5 mmol) are mixed at 20° C. under nitrogen for 2 hours. Ether is removed in vacuo at 0.1 mmHg vacuum at 20° C. for 5 hours to give 0.5 grams of the boron trifluoride etherate complex of 1,4 butanediol. Methylene chloride (2 mL) is added. The mixture is added dropwise over a 4 hour period at 0° C. to a solution of glycidyl ethyl ether (102 grams, 1 mole) and monomer VIIIa (0.6 grams, 1 mmole) from Example 2, in methylene chloride (100 mL). The mixture is stirred at 20° C. for 20 hours. The mixture is diluted with methylene chloride (100 mL), washed with saturated sodium bicarbonate, washed with water, and dried over magnesium sulfate. The solvents are removed in vacuo to obtain the poly(glycidyl ethyl ether) degradable plastic.

### Example 9

### Preparation of Polyvinyl Ethyl Ether Degradable Plastic

A mixture of montmorillonite (3.0 mg) and toluene (30 grams) under nitrogen atmosphere is heated to 45° C. The mixture is added dropwise at 45° C. over a one hour period to a solution of ethyl vinyl ether (36 grams, 0.5 mole) that is 0.7 weight % of water, and monomer VIIIb (0.6 grams, 1 mmole) prepared as in Example 3. The mixture is heated at 60° C. for one hour. The mixture is cooled to 20° C. Triethylamine (10 microliters) is added. The solvents are removed in vacuo to obtain the polyvinyl ethyl ether degradable plastic.

### Example 10

### Preparation of Polystyrene Degradable Plastic

Equimolar amounts of monosodium citrate and sodium bicarbonate encapsulated in vegetable oil (54.8% of the batch), 30.5% of poly alpha methyl styrene, 12.0% of styrene-ethylene/butylene-styrene block copolymer, 7.5% of white mineral oil, 0.2% silica, and monomer VIIIc (0.5% by weight) prepared as in Example 4, are fed continuously into a mixer resulting in a masterbatch mix. The masterbatch is extruded. The extrudate is melted at a temperature of 150° C. Liquid carbon dioxide is injected as a blowing agent. The resulting mixture is extracted. The mixture is cooled and dried to obtain polystyrene degradable plastic as a foam sheet.

### Example 11

### Preparation of Poly Methyl Methacrylate Degradable Plastic

Methyl methacrylate (47 grams), toluene (700 mL), monomer VIIId (0.25 grams) prepared as in Example 5, and 1.91 grams of ethyl α-lithioisobutyrate are mixed and stirred 1 hour. The polymerization is stopped by adding 25 mL of methanol. The crude polymer is precipitated by the addition of hexane. The polymer is reprecipitated from toluene into hexane twice. The polymer is washed with water to remove alkaline initiator residue. The polymer is dried to a constant weight in vacuo to obtain the polymethacrylate degradable plastic.

### Example 12

### Preparation of Polyisocyanate Degradable Plastic

4,4-Methylenebis(cyclohexyl isocyanate) (396 parts) is mixed with monomer VIIIe (3 parts) prepared as in Example 6. The mixture is heated with 4,4-methylene bis(aniline) at a ratio of 1.0 isocyanate groups to 0.98 amino groups, at 135° C. for 9 hours to obtain the polyisocyanate degradable plastic.

### Example 13

### Photodegradation of Degradable Plastics

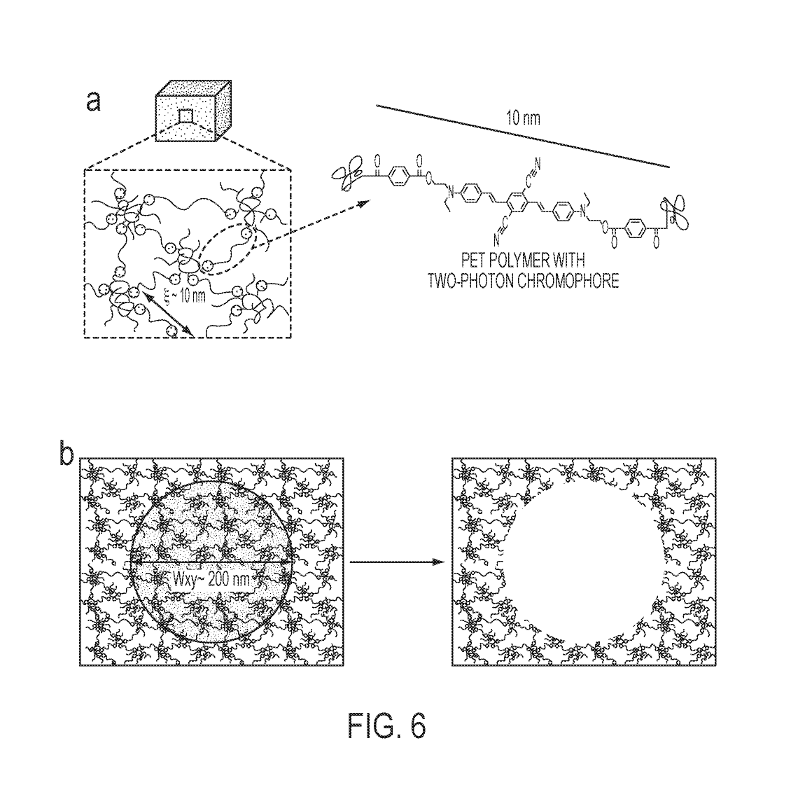

Two-photon induced degradation and complete erosion of photodegradable plastics and packaging materials are performed. Poly(ethylene terephthalate) (PET)-based photodegradable plastics are obtained from Example 7 (FIG. 6a). As shown in FIG. 6(b), focused, light of 850 nm (25 mW) focused on a circular region that is 200 nm in diameter induces complete erosion of the plastic. The light irradiation is carried out for 1 second until the chromophore containing sites can be cleaved locally. Photocleavage degrades the plastic into the polymer chains, oligomers, and monomers that make up the plastic, at the irradiated regions (FIG. 6c).

It should be noted that as used herein and in the appended claims, the singular forms “a”, “an”, and “the” include plural reference unless the context clearly dictates otherwise. Unless defined otherwise, all technical and scientific terms used herein have the same meanings as commonly understood by one of ordinary skill in the art. Although any methods and materials similar or equivalent to those described herein can be used in the practice or testing of embodiments disclosed, the preferred methods, devices, and materials are now described.

The term “alkyl” or “alkyl group” refers to a branched or unbranched hydrocarbon or group of 1 to 20 carbon atoms, such as but not limited to methyl, ethyl, n-propyl, isopropyl, n-butyl, isobutyl, t-butyl, octyl, decyl, tetradecyl, hexadecyl, eicosyl, tetracosyl and the like. “Cycloalkyl” or “cycloalkyl groups” are branched or unbranched hydrocarbons in which all or some of the carbons are arranged in a ring, such as but not limited to cyclopentyl, cyclohexyl, methylcyclohexyl and the like. The term “lower alkyl” includes an alkyl group of 1 to 10 carbon atoms.

The term “aryl” or “aryl group” refers to monovalent aromatic hydrocarbon radicals or groups consisting of one or more fused rings in which at least one ring is aromatic in nature. Aryls may include but are not limited to phenyl, napthyl, biphenyl ring systems and the like.

Although the present technology has been described in considerable detail with reference to certain preferred embodiments thereof, other versions are possible. Therefore the spirit and scope of the appended claims should not be limited to the description and the preferred versions contained within this specification.

1. A polymer resin having a polymeric backbone, the polymer resin comprising a first repeating unit and a second repeating unit, wherein the first repeating unit has a two-photon absorbing chromophore in the polymeric backbone.

2. The resin of claim 1, wherein the two-photon absorbing chromophore comprises a moiety of Formula I: 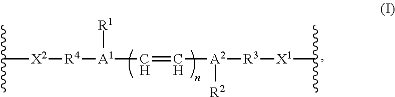
wherein
A¹ is aryl, heteroaryl, substituted aryl, cycloalkyl, heterocycloalkyl, methine, vinyl, substituted vinyl, aryl group fused to the bonded C atom, or cyclic compound fused to the bonded C atom;
A² is aryl, heteroaryl, substituted aryl, cycloalkyl, heterocycloalkyl, methine, vinyl, substituted vinyl, aryl group fused to the bonded C atom, or cyclic compound fused to the bonded C atom;
R¹ is —H, —C≡N, —OH, —O-alkyl, —C(═O)—OMe, —NH-alkyl, —N═N-alkyl, —CH═N-alkyl, —SH, —S-alkyl, —S(═O)-alkyl, —SO₂-alkyl, or —SO₃H;
R² is —H, —C≡N, —OH, —O-alkyl, —C(═O)—OMe, —NH-alkyl, —N═N-alkyl, —CH═N-alkyl, —SH, —S-alkyl, —S(═O)-alkyl, —SO₂-alkyl, or —SO₃H;
R³ is arylene, alkenylene, or a bivalent cyclic compound;
R⁴ is arylene, alkenylene, or a bivalent cyclic compound;
X¹ is B, C, N, Si, O, P, S, Se, or As;
X² is B, C, N, Si, O, P, S, Se, or As; and
n is an integer from 1 to 20.

3. The resin of claim 1, wherein the two-photon absorbing chromophore comprises a moiety selected from the formulae: 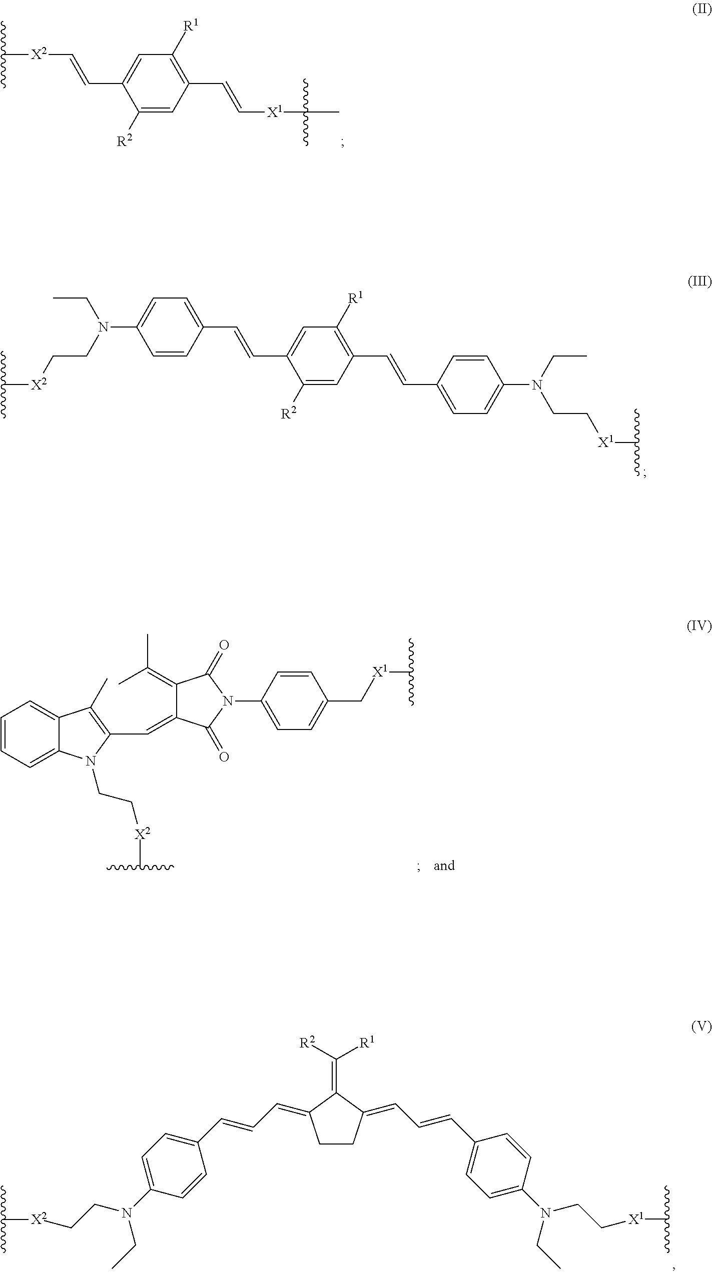
wherein
R¹ is —H, —C≡N, —OH, —O-alkyl, —C(═O)—OMe, —NH-alkyl, —N═N-alkyl, —CH═N-alkyl, —SH, —S-alkyl, —S(═O)-alkyl, —SO₂-alkyl, or —SO₃H;
R² is —H, —C≡N, —OH, —O-alkyl, —C(═O)—OMe, —NH-alkyl, —N═N-alkyl, —CH═N-alkyl, —SH, —S-alkyl, —S(═O)-alkyl, —SO₂-alkyl, or —SO₃H;
X¹ is B, C, N, Si, O, P, S, Se, or As; and
X² is B, C, N, Si, O, P, S, Se, or As.

4. The resin of claim 1, wherein the first repeating unit is present in the polymer resin in an amount of not more than about 2% by weight.

5. The resin of claim 1, wherein the second repeating unit comprises —(CH₂)n-O—, —CH(Me)-CH₂—O—, —CH₂—CH(OH)—CH₂—O—, —CH(CH₂OH)—CH₂—O—, —CH₂—C(Me)₂-CH₂—O—, —CH₂—C(CH₂OH)₂—CH₂—O—, or a combination thereof, wherein n=2-6.

6. The resin of claim 1, wherein the second repeating unit comprises —C(═O)—Ar—C(═O)—CH₂—CH₂—O—, —C(═O)—NH—Ar—CH₂—Ar—NH—C(═O)—O—CH₂—CH₂—O—, —C(═O)—X₃—NH—, or —C(═O)—X₃—O—, wherein:
X₃ is —CH((C₁-C₆)alkyl)-, —(CH₂)n-, —Ar—C(═O)—NH—Ar—, or —(CH₂)n-C(═O)—NH—(CH₂)m-C(═O)—;
Ar is 1,4-phenylene, 1,3-phenylene, or 1,2-phenylene;
m=2, 3, 4, 5, or 6; and
n=2, 3, 4, 5, or 6.

7. The resin of claim 1, wherein the resin further comprises a third repeating unit, wherein the third repeating unit comprises —C(═NH)—Ar—C(═NH)—O—, —C(═O)—Ar—C(═O)—O—, —C(═O)—CH₂—CH₂—CH₂—CH₂—C(═O)—O—, or a combination thereof, wherein
Ar is 1,4-phenylene, 1,3-phenylene, or 1,2-phenylene.

8. The resin of claim 1, wherein the second repeating unit comprises —R⁷—O—X₄—O—R⁷—O—, wherein:
R⁷ is —CH₂—CHOH—CH₂—; and
X₄ is —Ar—C(Me)₂-Ar—, —Ar—C(CF₃)₂—Ar—, a novolac resin, a phenol novolac resin, a cresol novolac resin, -alkylidene-, or a combination thereof, wherein
Ar is 1,4-phenylene, 1,3-phenylene, or 1,2-phenylene.

9.-11. (canceled)

12. The resin of claim 1, wherein the second repeating unit comprises —CH₂—CR⁸R⁹—; wherein
R⁸=H, or Me; and
R⁹=H, COOH, COOR¹⁰, CONR¹¹R¹², Ph, Cl, OAc, or Me; wherein
R¹⁰ is hydrogen, methyl, ethyl, propyl, or butyl;
R¹¹ is hydrogen, or methyl; and
R¹² is hydrogen, or methyl.

13. The resin of claim 1, wherein the resin is degradable upon a two-photon excitation.

14.-28. (canceled)

29. A method of preparing a polymer resin, the method comprising:
polymerizing a first monomer and a second monomer, wherein the first monomer has a two-photon absorbing chromophore, and wherein the two-photon absorbing chromophore is incorporated into a backbone of the polymer resin.

30. The method of claim 29, wherein the polymerizing comprises polymerizing with the first monomer having a two-photon absorbing chromophore comprising a moiety of Formula VI: 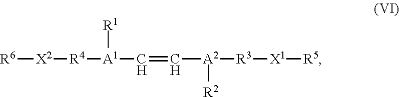
wherein
A¹ is aryl, heteroaryl, substituted aryl, cycloalkyl, heterocycloalkyl, methine, vinyl, substituted vinyl, aryl group fused to the bonded C atom, or cyclic compound fused to the bonded C atom;
A² is aryl, heteroaryl, substituted aryl, cycloalkyl, heterocycloalkyl, methine, vinyl, substituted vinyl, aryl group fused to the bonded C atom, or cyclic compound fused to the bonded C atom;
R¹ is —H, —C≡N, —OH, —O-alkyl, —C(═O)—OMe, —NH-alkyl, —N═N-alkyl, —CH═N-alkyl, —SH, —S-alkyl, —S(═O)-alkyl, —SO₂-alkyl, or —SO₃H;
R² is —H, —C≡N, —OH, —O-alkyl, —C(═O)—OMe, —NH-alkyl, —N═N-alkyl, —CH═N-alkyl, —SH, —S-alkyl, —S(═O)-alkyl, —SO₂-alkyl, or —SO₃H;
R³ is arylene, alkenylene, or a bivalent cyclic compound;
R⁴ is arylene, alkenylene, or a bivalent cyclic compound;
X¹ is B, C, N, Si, O, P, S, Se, or As;
X² is B, C, N, Si, O, P, S, Se, or As;
R⁵ is a hydrogen, an alkylene, a substituted alkylene, an unsaturated ester, an alkylene substituted —C(═O)-Ph, an alkylene oxide, or an acyl isocyanate;
R⁶ is a hydrogen, an alkylene, a substituted alkylene, an unsaturated ester, an alkylene substituted —C(═O)-Ph, an alkylene oxide, or an acyl isocyanate; and
n is an integer from 1 to 20.

31. (canceled)

32. The method of claim 29, wherein the polymerizing comprises polymerizing with the first monomer comprising a compound of Formula VII: 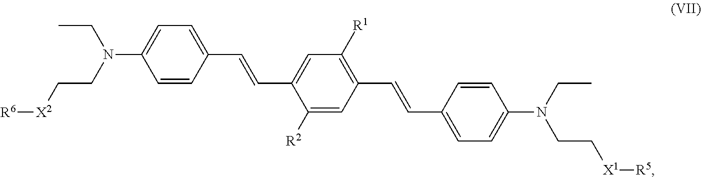
wherein
R¹ is —H, —C≡N, —OH, —O-alkyl, —C(═O)—OMe, —NH-alkyl, —N═N-alkyl, —CH═N-alkyl, —SH, —S-alkyl, —S(═O)-alkyl, —SO₂-alkyl, or —SO₃H;
R² is —H, —C≡N, —OH, —O-alkyl, —C(═O)—OMe, —NH-alkyl, —N═N-alkyl, —CH═N-alkyl, —SH, —S-alkyl, —S(═O)-alkyl, —SO₂-alkyl, or —SO₃H;
R⁵ is hydrogen; an alkylene; a substituted alkylene; an unsaturated ester; an alkylene substituted —C(═O)-Ph; an alkylene oxide; or an acyl isocyanate; and
R⁶ is hydrogen; an alkylene; a substituted alkylene; an unsaturated ester; an alkylene substituted —C(═O)-Ph; an alkylene oxide; or an acyl isocyanate,
X¹ is B, C, N, Si, O, P, S, Se, or As; and
X² is B, C, N, Si, O, P, S, Se, or As.

33. (canceled)

34. The method of claim 29, wherein the polymerizing further comprises polymerizing a third monomer, wherein the third monomer comprises terephthalic acid, isophthalic acid, orthophthalic acid, phthalic anhydride, hexanedioic acid, or a combination thereof.

35. The method of claim 29, wherein the polymerizing further comprises polymerizing with a third monomer, wherein the third monomer comprises ethylene glycol, 1,4-butanediol, 1,2-propanediol, 1,3-propanediol, glycerol, neopentyl glycol, trimethylol propane, or a combination thereof.

36. The method of claim 29, wherein the polymerizing comprises polymerizing with a second monomer comprising acrylic acid, methacrylic acid, methyl acrylate, methyl methacrylate, ethyl methacrylate, propyl methacrylate, butyl methacrylate, diglycidyl ether, bisphenol A diglycidyl ether, bisphenol F diglycidyl ether, epoxidized novolac, epoxy phenol novolac, epoxy cresol novolac, aliphatic diglycidyl ether, glycidylamine epoxide, or a combination thereof.

37. The method of claim 29, wherein the polymerizing comprises polymerizing with a second monomer comprising polystyrene, polyethylene, polyvinyl, polyacrylate, poly(ethylene terephthalate), polyvinylchloride, polypropylene, polyvinyl acetate, polyester, polyamide, polyacrylamide, polyepoxide, polyurethane, or a combination thereof.

38.-42. (canceled)

43. A method of degrading a polymer, the method comprising:
exposing the polymer to light, the polymer comprising a first repeating unit and a second repeating unit, wherein the first repeating unit has a two-photon absorbing chromophore in a polymeric backbone of the polymer.

44. The method of claim 43 wherein the two-photon absorbing chromophore is of Formula I: 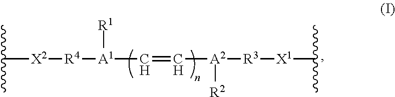
wherein
A¹ is aryl, heteroaryl, substituted aryl, cycloalkyl, heterocycloalkyl, methine, vinyl, substituted vinyl, aryl group fused to the bonded C atom, or cyclic compound fused to the bonded C atom;
A² is aryl, heteroaryl, substituted aryl, cycloalkyl, heterocycloalkyl, methine, vinyl, substituted vinyl, aryl group fused to the bonded C atom, or cyclic compound fused to the bonded C atom;
R¹ is —H, —C≡N, —OH, —O-alkyl, —C(═O)—OMe, —NH-alkyl, —N═N-alkyl, —CH═N-alkyl, —SH, —S-alkyl, —S(═O)-alkyl, —SO₂-alkyl, or —SO₃H;
R² is —H, —C≡N, —OH, —O-alkyl, —C(═O)—OMe, —NH-alkyl, —N═N-alkyl, —CH═N-alkyl, —SH, —S-alkyl, —S(═O)-alkyl, —SO₂-alkyl, or —SO₃H;
R³ is arylene, alkenylene, or a bivalent cyclic compound;
R⁴ is arylene, alkenylene, or a bivalent cyclic compound;
X¹ is B, C, N, Si, O, P, S, Se, or As;
X² is B, C, N, Si, O, P, S, Se, or As; and
n is an integer from 1 to 20.

45. The method of claim 43, wherein the exposing comprises exposing the polymer comprising a two-photon absorbing chromophore selected from the formulae: 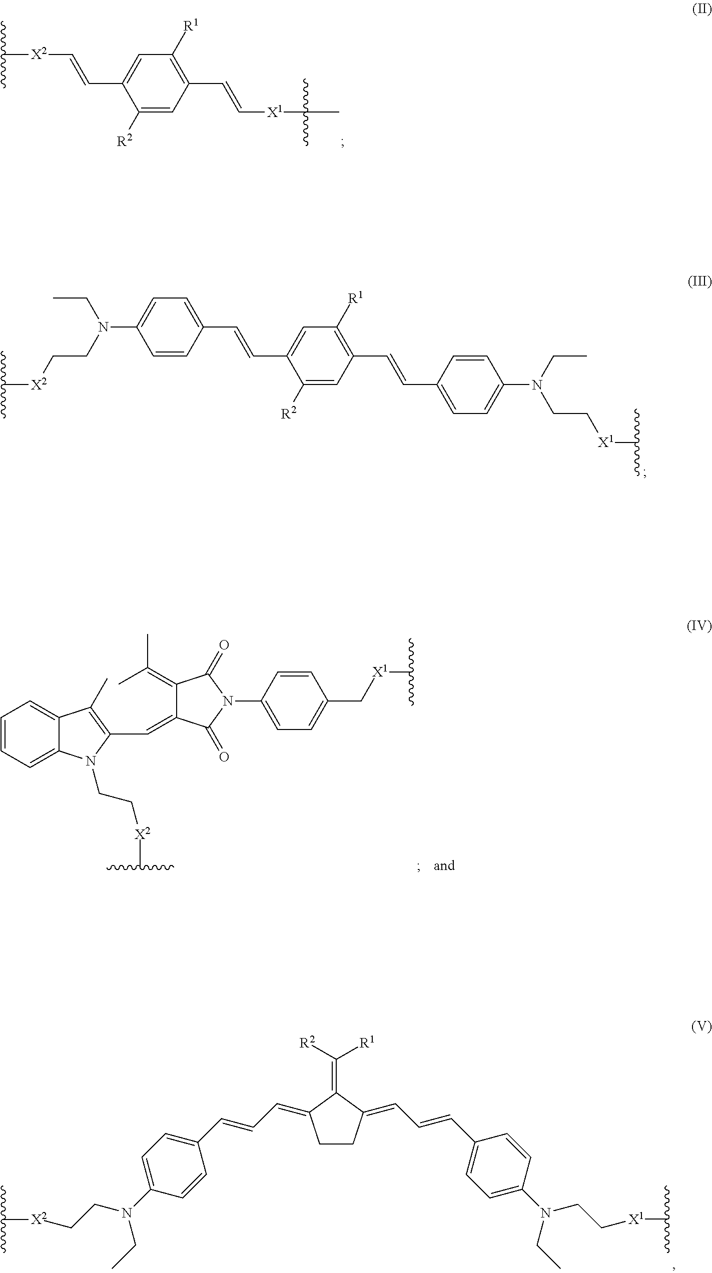
wherein
R¹ is —H, —C≡N, —OH, —O-alkyl, —C(═O)—OMe, —NH-alkyl, —N═N-alkyl, —CH═N-alkyl, —SH, —S-alkyl, —S(═O)-alkyl, —SO₂-alkyl, or —SO₃H;
R² is —H, —C≡N, —OH, —O-alkyl, —C(═O)—OMe, —NH-alkyl, —N═N-alkyl, —CH═N-alkyl, —SH, —S-alkyl, —S(═O)-alkyl, —SO₂-alkyl, or —SO₃H;
X¹ is B, C, N, Si, O, P, S, Se, or As; and
X² is B, C, N, Si, O, P, S, Se, or As.

46. The method of claim 43, wherein the exposing comprises exposing a polymer having the first repeating unit present in the polymer in an amount of not more than 2% by weight.

47. The method of claim 43, wherein the polymer degrades upon a two-photon excitation.

48. The method of claim 43, wherein exposing the polymer to light comprises exposing the polymer to light from two lasers, a diode laser or combination thereof.

49. (canceled)
